(19) United States
(12) Patent Application Publication
(10) Pub. No.: US 2016/0297263 A1
(43) Pub. Date: Oct. 13, 2016

(54) TIRE POSITION DETERMINATION SYSTEM

(71) Applicant: KABUSHIKI KAISHA TOKAI RIKA DENKI SEISAKUSHO, Aichi (JP)

(72) Inventors: Naoki WATANABE, Aichi (JP); Yuta TSUCHIKAWA, Aichi (JP); Katsuhide KUMAGAI, Aichi (JP); Masahiro MATSUSHITA, Aichi (JP)

(73) Assignee: KABUSHIKI KAISHA TOKAI RIKA DENKI SEISAKUSHO, Aichi (JP)

(21) Appl. No.: 15/038,494

(22) PCT Filed: Nov. 19, 2014
(86) PCT No.: PCT/JP2014/080618

§ 371 Date: May 23, 2016

(30) Foreign Application Priority Data
Nov. 25, 2013 (JP) 2013-243100

(51) Int. Cl. B60C 23/04

(52) U.S. Cl. CPC B60C 23/0435; B60C 23/0416; B60C 23/0447; B60C 23/0488; B60C 23/0455

(57) ABSTRACT

A tire position determination system is provided with: a plurality of tire air pressure transmitters respectively attached to a plurality of tires and each capable of transmitting a first radio wave signal including air pressure data and a tire ID; a plurality of axle rotation detection units that are respectively installed in association with a plurality of axles and that generate axle rotation information by detecting rotation of a corresponding one of the plurality of axles; and a receiver mounted to a vehicle body and capable of receiving the first radio wave signal from each of the plurality of tire air pressure transmitters.

### TECHNICAL FIELD

The present invention relates to a tire position determination system.

### BACKGROUND ART

Patent Document 1 discloses a known example of a tire position determination system (auto-location function) that automatically determines tire positions to monitor the air pressure of each tire. The system of Patent Document 1 includes first sensors (4a to 4d), which are respectively arranged in wheels (2a to 2d), four second sensors (5a to 5d), which correspond to specific positions of a vehicle, and a measurement system (3), which determines wheel positions. The first sensors transmit signals (S4a to S4d) that indicate wheel positions to the measurement system. The second sensors measure angular positions of wheels and calculate measurement values (S5a to S5d) of the wheel angle positions. The measurement system determines the wheel positions by obtaining phase positions (W1a to W3a and W1b to W3b) of the signals of the first sensors from the measurement values and checking whether or not the phase positions remain within predetermined allowable ranges (WTa and WTb) during a predetermined monitoring period.

### PRIOR ART DOCUMENT

### Patent Document

Patent Document 1: Japanese Laid-Open Patent Publication No. 2011-527971

### SUMMARY OF THE INVENTION

### Problems that are to be Solved by the Invention

Such type of a tire position determination system shows the determination result of a tire position on a display. When the determination accuracy is low, the displayed content changes frequently. This adversely affects the reliability of the displayed content. Further, if an incorrect determination result of a tire position is shown, a process may be performed based on the incorrect displayed content (for example, a tire that need not be replaced may be replaced). To correctly determine a tire position, more time may be used to perform the determination. However, much time would be used until the determination result is displayed. Thus, there is a need for quickly determining the tire positions.

It is an object of the present invention to provide a tire position determination system that quickly shows a tire position determination result on a display and ensures the reliability of the displayed content.

### Means for Solving the Problem

One aspect of the present invention is a tire position determination system that includes tire pressure transmitters, axle rotation detectors, and a receiver. The tire pressure transmitters are respectively coupled to tires. Each of the tire pressure transmitters is capable of transmitting a first radio wave signal that includes pressure data and a tire ID. The axle rotation detectors are respectively arranged on axles. Each of the axle rotation detectors detects rotation of a corresponding one of the axles and generates axle rotation information. The receiver is arranged on a vehicle body. The receiver is capable of receiving the first radio wave signal from each of the tire pressure transmitters. Each of the tire pressure transmitters transmits a second radio wave signal, which includes an ID of the tire and data indicating that the tire pressure transmitter has reached a specific position on the rotation path of the tire. The receiver includes a position determination unit, a display, a re-determination unit, a validation unit, and a display controller. The position determination unit obtains the axle rotation information from each of the axle rotation detectors whenever receiving the second radio wave signal from each of the tire pressure transmitters and specifies an ID of a tire that rotates in synchronism with each of the axles based on the obtained axle rotation information to determine tire positions of the tires and generate a first determination result. The display shows the first determination result of the position determination unit. The re-determination unit obtains, during a period in which the display shows the first determination result, the axle rotation information from each of the axle rotation detectors whenever receiving the second radio wave signal from the tire pressure transmitter and specifies an ID of a tire that rotates in synchronism with each of the axles based on the obtained axle rotation information to determine tire positions of the tires and generate a second determination result. The validation unit checks the validity of the first determination result based on the first determination result and the second determination result. The display controller shows one of the first determination result and the second determination result on the display based on a check result of the validation unit.

In the above structure, it is preferred that the position determination unit determine a tire position under a determination condition set in accordance with a determination order.

In the above structure, it is preferred that during a period in which the display shows the first determination result, the re-determination unit perform determination of the tire positions a number of times to generate a plurality of determination results including a second determination result and a third determination result and that the validation unit take a majority vote with the first determination result and the plurality of determination results to determine the validity of the first determination result.

In the above structure, it is preferred that the re-determination unit determine tire positions of the tires to generate a third determination result by, whenever the second radio wave signal is received from the tire pressure transmitter, after the second determination result is generated while the display shows the first determination result, obtaining the axle rotation information from each of the axle rotation detectors and specifying an ID of a tire that rotates in synchronism with each of the axles based on the obtained axle rotation information and that the validation unit check the validity of the first determination result by taking a majority vote with the first determination result, the second determination result, and the third determination result.

In the above structure, it is preferred that the re-determination unit determine a tire position under a stricter determination condition than the determination condition of a tire position for the position determination unit.

In the above structure, it is preferred that the position determination unit collect statistics on the axle rotation information for each of the IDs and calculate a distribution of the axle rotation information of each of the axles for each of the IDs to specify an ID of a tire that rotates in synchronism with each of the axles based on the calculated distribution and determine tire positions of the tires.

In the above structure, it is preferred that a first time period, during which transmission of a radio wave signal is enabled, and a second time period, during which transmission of a radio wave signal is temporarily stopped, be alternately repeated in an operation of the tire pressure transmitter and that each of the tire pressure transmitters obtain multiple pieces of timing information indicating a time at which each of the tire pressure transmitters reached a specific position on a rotation path of the tire during the first time period and transmit the second radio wave signal including an ID of the tire and the multiple pieces of timing information during the second time period.

### Effect of the Invention

The present invention quickly shows a tire position determination result on a display and ensures the reliability of the displayed content.

### BRIEF DESCRIPTION OF THE DRAWINGS

FIG. 1 is a diagram showing a first embodiment of a tire position determination system.

FIG. 2 is a diagram showing a centripetal component of gravity that is detected by a tire pressure transmitter.

FIGS. 3A and 3B are communication sequence diagrams of the tire pressure transmitter.

FIG. 4 is a diagram showing a sampling logic of the centripetal component of gravity.

FIG. 5 is a distribution chart showing pulse count values of wheels for a certain ID.

FIG. 6 is a distribution chart showing a pulse count value generated for an ID.

FIG. 7 shows equations for calculating an average deviation and a standard deviation.

FIG. 8 is a flowchart showing a display logic of a tire position determination result.

FIG. 9 is a diagram showing a second embodiment of a tire position determination system.

FIG. 10 is a diagram showing a vehicle speed determination logic.

FIG. 11 is a table showing the relationship of the vehicle speed and a weighting coefficient.

FIG. 12 is a diagram showing an acceleration/deceleration determination logic.

FIG. 13 is a table showing the relationship of acceleration/determination and weighting.

FIG. 14 is a flowchart showing a display logic of a tire position determination result.

### EMBODIMENTS OF THE INVENTION

### First Embodiment

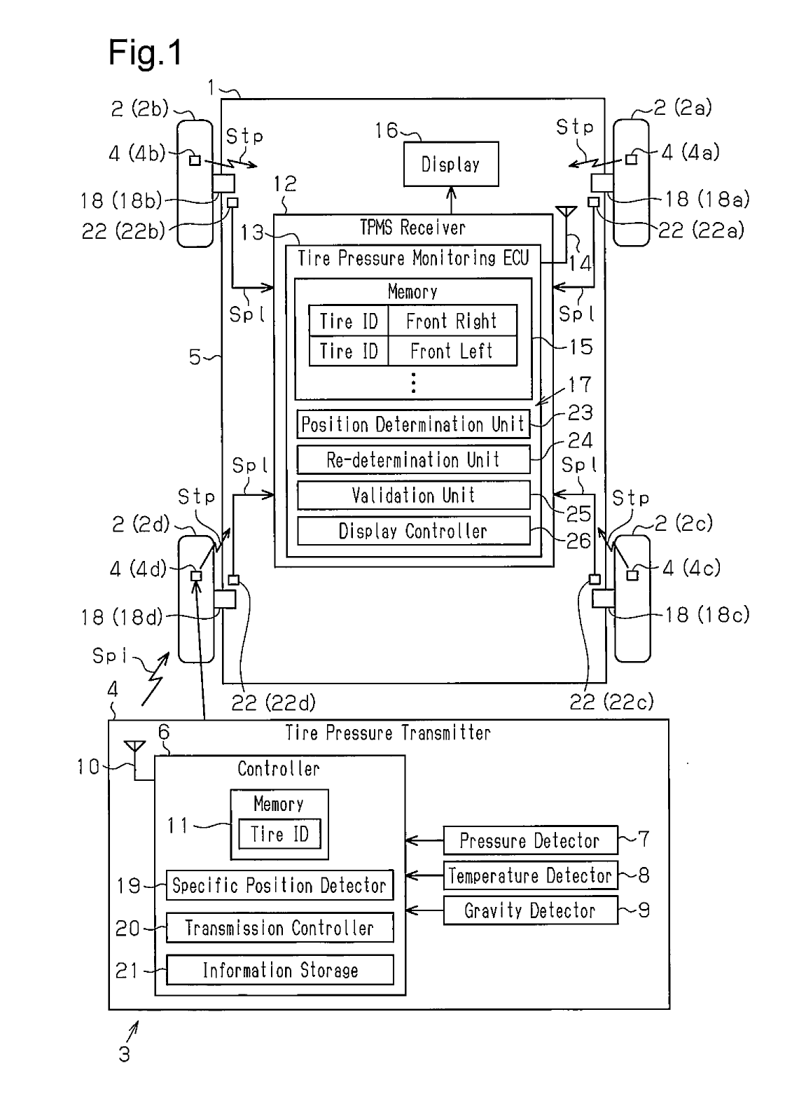

One embodiment of a tire position determination system will now be described with reference to FIGS. 1 to 8.

As shown in FIG. 1, a vehicle 1 includes a tire pressure monitoring system 3 (TPMS) that monitors the air pressure and the like of tires 2 (2a to 2d). The tire pressure monitoring systems 3 include tire pressure transmitters 4 (4a to 4d, also referred to as tire valves), which are respectively coupled to the tires 2a to 2d. The tire pressure transmitters 4 transmit to a vehicle body 5 a first radio wave signal (for example, tire pressure signal Stp) that includes at least an ID and pressure data associated with the ID. Thus, the pressure of each of the tires 2a to 2d is monitored in the vehicle body 5. In one example, the first radio wave signal is a tire pressure signal Stp.

Each of the tire pressure transmitters 4 includes a controller 6 that controls operation of the tire pressure transmitter 4, a pressure detector 7 that detects tire pressure, a temperature detector 8 that detects the temperature of the tire 2, a gravity detector 9 that detects the gravity generated at the tire pressure transmitter 4, and a transmission antenna 10 that enables transmission of a radio wave signal. The controller 6 includes a memory 11 that stores a tire ID (valve ID) as an ID unique to the tire pressure transmitter 4. It is preferred that the pressure detector 7 be, for example, a pressure sensor. It is preferred that the temperature detector 8 be, for example, a temperature sensor. It is preferred that the gravity detector 9 be an acceleration sensor (G-sensor). It is preferred that the transmission antenna 10 be capable of, for example, transmitting a radio wave signal in the ultrahigh-frequency (UHF) band.

The vehicle body 5 includes a receiver 12 (hereinafter referred to as TPMS receiver 12) that receives the tire pressure signal Stp from each of the tire pressure transmitters 4a to 4d to monitor the pressure of each of the tires 2a to 2d. The TPMS receiver 12 includes a tire pressure monitoring electronic control unit (ECU) 13 that controls operation of the TPMS receiver 12 and a reception antenna 14 that enables the reception of a radio wave signal. The tire pressure monitoring ECU 13 includes a memory 15 that stores IDs (tire IDs) of the tire pressure transmitters 4a to 4d in association with tire positions. A display 16, which is arranged in, for example, an instrument panel in the passenger compartment, is connected to the TPMS receiver 12.

Each tire pressure transmitter 4 transmits the tire pressure signal Stp from the transmission antenna 10 at predetermined time intervals regularly or irregularly or when detecting rotation of the tires 2 with the gravity detector 9. For example, it is preferred that the tire pressure signal Stp be a signal including, for example, a tire ID, pressure data, and temperature data.

When the reception antenna 14 receives the tire pressure signal Stp from each of the tire pressure transmitters 4a to 4d, the TPMS receiver 12 verifies the tire ID in the tire pressure signal. When the tire ID is verified, the TPMS receiver 12 checks the pressure data of the tire pressure signal Stp. When the pressure data is less than or equal to a low-pressure threshold value, the TPMS receiver 12 shows on the display 16 that the pressure of the corresponding tire is low in association with the tire position. The TPMS receiver 12 performs the tire pressure determination on each tire pressure signal Stp that is received to monitor the pressure of each of the tires 2a to 2d.

The TPMS receiver 12 includes a tire position determination function (tire position determination system 17) that automatically determines the position (front, rear, left, or right) on the vehicle body 5 where each of the tires 2a to 2d is coupled, that is, performs auto-location. For a number of times, the tire position determination system 17 performs an operation for obtaining the rotation positions (rotation amounts) of the axles 18 (18a to 18d) when detecting that the tire pressure transmitters 4a to 4d have reached specific positions on a rotation path of the corresponding tires. Then, the tire position determination system 17 determines whether or not the tire of each tire ID is rotating in synchronism with the rotation position (rotation amount) of each of the axles 18a to 18d and associates the plurality of tire IDs with the axles 18a to 18d. This determines the positions of the tires 2a to 2d.

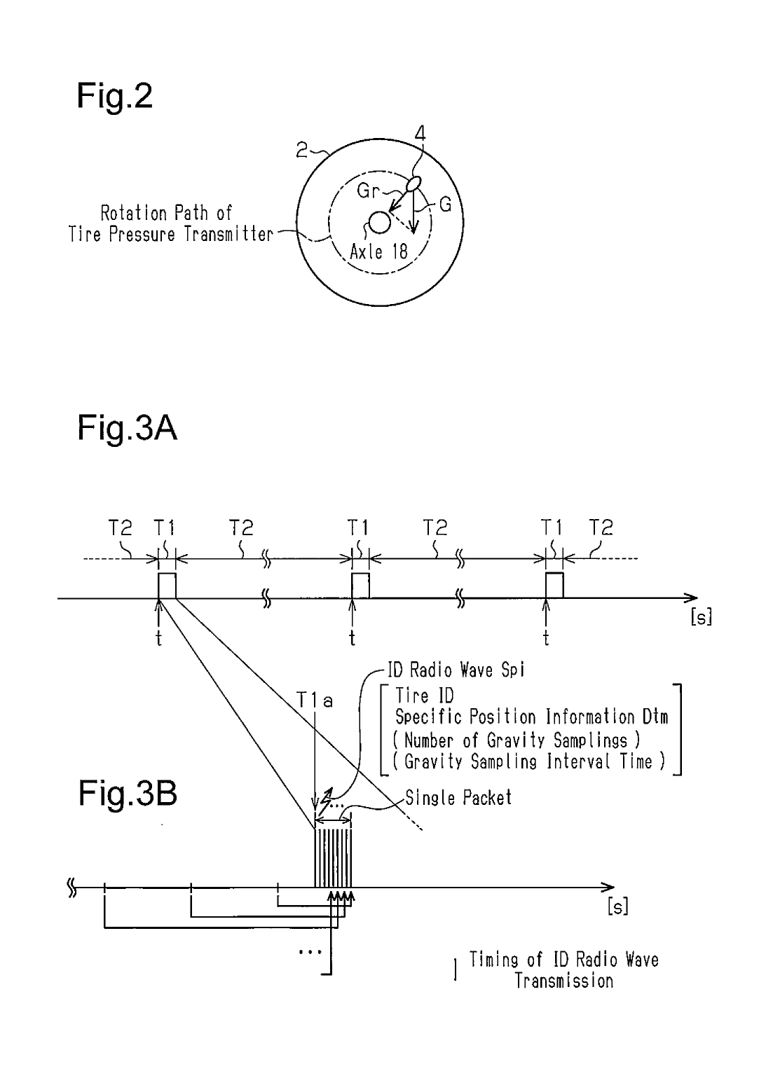

FIG. 2 shows a centripetal component of gravity that is detected by the gravity detector 9. It is preferred that the gravity detector 9 detect a gravitational centripetal component Gr in the axle direction (tire radial direction) relative to gravity G as the gravity applied to the tire pressure transmitter 4. The gravitational centripetal component Gr is −1G” or “+1G” as long as, for example, centrifugal force is not taken into account when the tire pressure transmitter 4 is located at a peak of the tire rotation path (twelve o'clock position or six o'clock position in the drawing). The detected gravitational centripetal component Gr may be a tangential component on the tire rotation path.

FIG. 3A shows a radio wave transmission sequence of the tire pressure transmitter 4. During operation of the tire pressure transmitter 4, it is preferred that a first time period T1, during which transmission of a radio wave is allowed, and a second time period T2, during which the transmission of a radio wave is temporarily stopped, are alternately repeated. It is preferred that the first time period T1 be a short time, for example, one second. It is preferred that the second time period T2 be a long time, for example, thirty seconds. In this manner, the tire pressure transmitter 4 repeats the transmission of a radio wave signal during a limited time of one second in intervals of approximately thirty seconds.

As shown in FIG. 1, each tire pressure transmitter 4 includes a specific position detector 19 and a transmission controller 20. The specific position detector 19 detects when the tire pressure transmitter 4 has reached a specific position on the rotation path of the tire 2. The transmission controller 20 transmits a second radio wave signal that indicates that the tire 2 has reached the specific position. In one example, the second radio wave signal is an ID radio wave signal Spi. The second radio wave signal includes at least an ID (tire ID). It is preferred that the specific position detector 19 and the transmission controller 20 be arranged in, for example, the controller 6. It is preferred that the specific position be, for example, a peak position on the rotation path of a tire. It is preferred that the ID radio wave signal Spi be transmitted a number of times in accordance with, for example, the number of times the peak position is detected. The tire pressure transmitter 4 transmits the ID radio wave signal Spi in the first time period T1.

It is preferred that the tire pressure transmitter 4 include an information storage 21 that holds at least one piece of specific position information Dtm indicating the time at which the tire pressure transmitter 4 reached the specific position in the second time period T2. For example, when the vehicle 1 is traveling at a low speed and the tire 2 rotates slowly, the peak position may not be detected a predetermined number of times in the first time period T1, which is relatively short. Thus, the tire pressure transmitter 4 detects the peak position in advance in the second time period T2, during which radio wave transmission is temporarily stopped. Further, for example, when a radio wave signal is transmitted only at a specific tire angle and the radio wave signal has a null value, the radio wave signal may be subsequently fixed to the null value. Taking this into account, the tire pressure transmitter 4 transmits a radio wave signal at an arbitrary tire angle. In this method, a radio wave signal is not fixed to a null value. This avoids the risk of greatly decreasing the reception rate of the TPMS receiver 12 when determining tire positions.

It is preferred that the specific position information Dtm be peak information indicating the time at which the tire pressure transmitter 4 has reached a peak position. The specific position information Dtm includes, for example, the number of gravity sampling points that indicates the number of times gravity sampling has been performed and a gravitation sampling interval time that is the interval at which gravity sampling is performed.

Referring to FIG. 3B, it is preferred that the information storage 21 detects the peak position a predetermined number of times (for example, eight times) in the second time period T2 prior to a starting point T1a of the first time period T1. In the first time period T1, the transmission controller 20 transmits at least one piece of specific position information Dtm, which is held in the information storage 21, together with the ID (tire ID) as the second radio wave signal (ID radio wave signal Spi). To finish the transmission of the single packet of the ID radio wave signal Spi in the first time period T1, the transmission controller 20 may successively transmit the ID radio wave signals Spi (transmission interval: 10 ms).

As shown in FIG. 1, the tire position determination system 17 includes a position determination unit 23. The position determination unit 23 is arranged in, for example, the tire pressure monitoring ECU 13. The position determination unit 23 receives the second radio wave signal (for example, ID radio wave signal Spi) and acquires axle rotation information Dc from the axle rotation detectors 22 (22a to 22d), which are capable of detecting rotation of the corresponding axles 18a to 18d, whenever the tire pressure transmitters 4 reach the specific positions. The position determination unit 23 collects statistics on the axle rotation information Dc for each ID (tire ID) to calculate a distribution of the axle rotation information Dc for each ID (tire ID). Further, the position determination unit 23 determines the tire positions by specifying the tires (ID1 to ID4) that rotate in synchronism with the axles 18a to 18d based on the distribution of the axle rotation information Dc. It is preferred that distribution be, for example, “variation,” “average of deviation,” or “standard deviation.”

Each of the axle rotation detectors 22a to 22d may be, for example, an antilock brake system (ABS) sensor arranged in each of the axles 18a to 18d. The axle rotation information Dc is, for example, the number of pulses detected by the ABS sensor, that is, a pulse count value. Further, each of the axle rotation detectors 22a to 22d uses a sensor arranged on the vehicle body 5 to detect a plurality of, for example, forty-eight teeth arranged on the axles 18a to 18d and provide the TPMS receiver 12 with a pulse signal Spl, which has the form of a square wave. When the position determination unit 23 detects both of a rising edge and a falling edge of the received pulse signal Spl, the axle position determination unit 23 detects ninety-six pulses (count value: zero to ninety-five) per tire rotation.

The position determination unit 23 treats each of a plurality of (eight in this example) ID radio wave signals Spi, which are received as one packet, as separate data. Whenever the position determination unit 23 receives the ID radio wave signal, the position determination unit 23 obtains the axle rotation information Dc of each of the axle rotation detectors 22a to 22d. The position determination unit 23 determines the position of each of the tires 2a to 2d by calculating the distribution of the axle rotation information Dc for each tire ID. Further, the position determination unit 23 back-calculates the axle rotation information Dc for each specific position, which is detected in the second time period T2 and held as the specific position information Dtm, and determines a tire position from the back-calculated value.

The tire position determination system 17 includes a re-determination unit 24, a validation unit 25, and a display controller 26. When showing a first determination result, which is the result of a former tire position determination, on the display 16, the re-determination unit 24 performs a separate tire position determination to obtain a second determination result, which is the result of a latter tire position determination. The validation unit 25 checks the validity of the first determination result based on the two determination results (first determination result and second determination result). The display controller 26 controls the display of the display 16 based on the check result checked by the validation unit 25. It is preferred that the re-determination unit 24, the validation unit 25, and the display controller 26 be arranged in, for example, the tire pressure monitoring ECU 13.

It is preferred that the determination condition of the former tire position determination be set in accordance with the order of determination. In this case, it is preferred that the position determination unit 23 perform the former tire position determination under a moderate condition. The moderate condition may be realized by, for example, setting a “threshold value” in the determination process to a low-level value (loose value) in the process of “variation,” “deviation,” or “standard deviation.” Further, the latter tire position determination may be performed under the same condition as the former tire position determination.

It is preferred that the re-determination unit 24 perform the latter tire position determination a number of times when the first determination result is shown on the display 16 to generate a plurality of determination results including the second determination result and a third determination result. In this case, the validation unit 25 may check the validity of the first determination result by taking a majority vote for the first determination result and the plurality of determination results. It is preferred that the display controller 26 show the largest determination result on the display 16 as a final tire position based on the result of the majority vote.

The operation of the tire position determination system 17 will now be described with reference to FIGS. 3 to 8.

Operation of Tire Position Determination

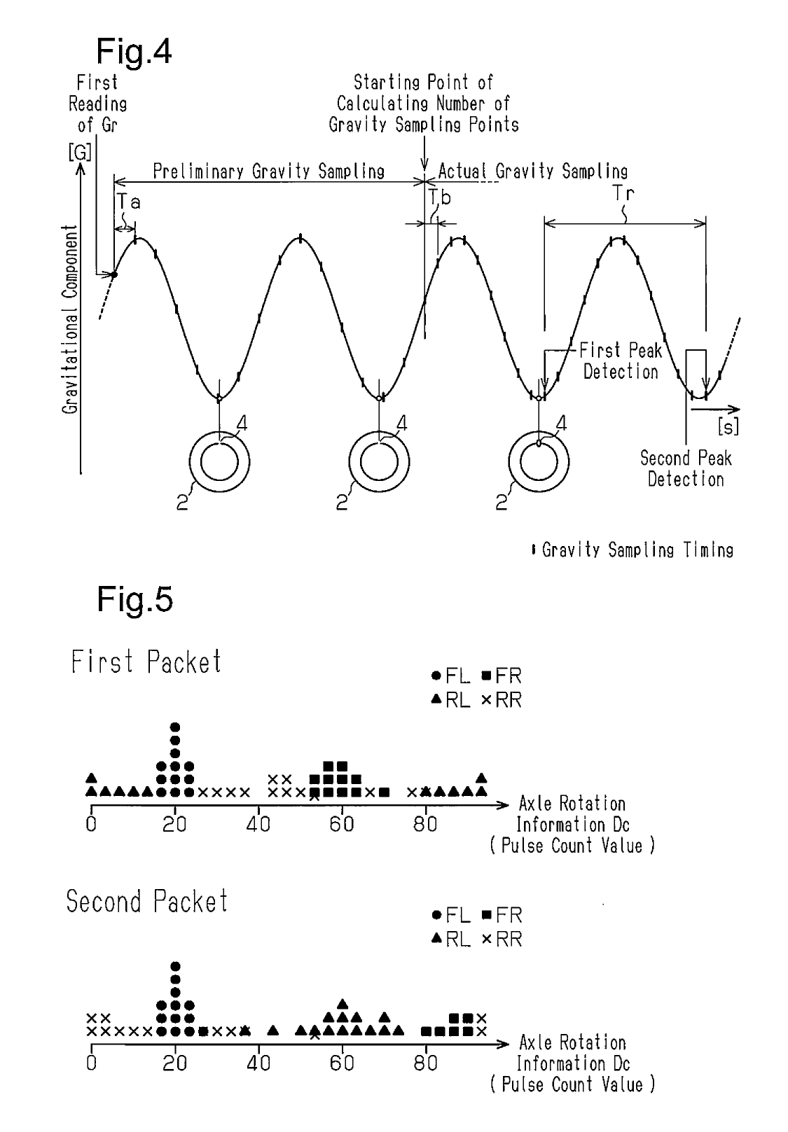

As shown in FIG. 4, in the second time period T2, the tire pressure transmitter 4 first reads the centripetal component Gr of gravity a predetermined time before starting the peak detection and sets a gravity sampling interval time Ta, which is relatively long, in accordance with the read gravitational centripetal component Gr to check the waveform of the gravity. The tire pressure transmitter 4 starts preliminary gravity sampling that detects the gravitational centripetal component Gr in the sampling interval time Ta.

In the preliminary gravity sampling, the tire pressure transmitter 4 first monitors where the peak is generated in the gravitational centripetal component Gr. When detecting the peak of the gravitational centripetal component Gr, the tire pressure transmitter 4 monitors the gravitational centripetal component Gr to locate the next peak and measure a single cycle of the preliminary gravity sampling. When detecting the peak of the gravitational centripetal component Gr again, the tire pressure transmitter 4 calculates the cycle of the preliminary gravity sampling based on the time between the former peak and the latter peak. The tire pressure transmitter 4 sets Tb, which is in accordance with the cycle of the preliminary gravity sampling, to the gravity sampling interval time used for actual gravity sampling. That is, since the number of gravity samplings per tire rotation is set to a specified value (for example, twelve), the optimal gravity sampling interval time Tb is set so that the number of times gravitational sampling is performed reaches the specified value when the actual gravity sampling is performed.

The tire pressure transmitter 4 performs actual gravity sampling in the gravity sampling interval time Tb. That is, the tire pressure transmitter 4 repeatedly detects the gravitational centripetal component Gr in the gravity sampling interval time Tb and detects peak positions for determining tire positions. In this example, a single cycle of the actual gravity sampling is set to Tr, which is the duration of a specified number of (for example, twelve) the gravity sampling interval time Tb.

When the information storage 21 detects a peak position through gravity sampling that is repeatedly performed during the gravity sampling interval time Tb, the information storage 21 stores the specific position information Dtm in the memory 11. Subsequently, the information storage 21 holds the specific position information Dtm in the memory 11 whenever detecting a peak.

As shown in FIG. 3, in the first time period T1, during which a radio wave can be transmitted, the transmission controller 20 transmits from the transmission antenna 10 at least one ID radio wave signal Spi that includes at least one piece of specific position information Dtm, which is held in the memory 11. The ID radio wave signal Spi includes at least a tire ID and the specific position information Dtm. It is preferred that the ID radio wave signal Spi include information of, for example, a tire ID, the number of gravity sampling points, and the gravity sampling interval time Tb. It is preferred that the ID radio wave signals Spi be successively transmitted in short intervals of, for example, approximately 100 ms, so that the radio wave signal Spi is entirely transmitted during the first time period T1.

Referring to FIG. 5, whenever the position determination unit 23 receives the ID radio wave signal Spi, the position determination unit 23 obtains the axle rotation information Dc of each of the axle rotation detectors 22a to 22d. In this example, the position determination unit 23 back-calculates the axle rotation information Dc from each piece of the specific position information Dtm (peak position). Further, the position determination unit 23 determines a tire position by collecting statistics of the back-calculated axle rotation information Dc and updating the statistics of the axle rotation information Dc whenever the position determination unit 23 receives a packet of the ID radio wave signal Spi. For example, as shown in FIG. 5, when the position determination unit 23 cannot specify a tire position from the distribution of the axle rotation information Dc calculated from the ID radio wave signal in the first packet, the position determination unit 23 updates the distribution of the axle rotation information Dc based on the ID radio wave signal Spi of the second packet to specify the tire position from the updated distribution. Nevertheless, when the position determination unit 23 cannot be specified, the position determination unit 23 repeats the same process on the third and following packets to update the distribution and determines the tire position from the newly updated distribution.

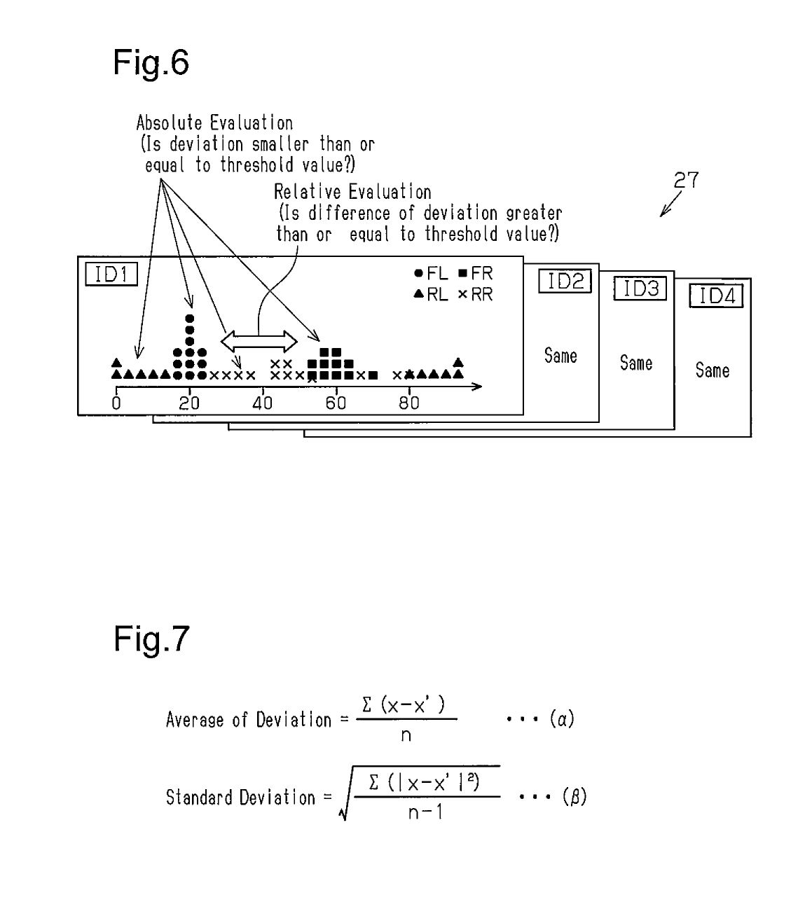

FIG. 6 shows an example of the tire position determination. The position determination unit 23 generates a distribution chart 27 for each tire ID as shown in FIG. 6. It is preferred that the position determination unit 23 perform absolute evaluation, which determines the validity of the distribution using only the axle rotation information Dc of each axle 18, and relative evaluation, which determines the validity of the distribution using the axle rotation information Dc of a plurality of axles 18, to determine a tire position based on the result of the absolute evaluation and the result of the relative evaluation. In the relative evaluation, the position determination unit 23 determines whether or not the subject tire has sufficient synchronization when compared to other tires. Examples of distribution include “average of deviation” and “standard deviation.” The average of deviation and the value of standard deviation decrease as the determination result becomes more desirable.

Referring to FIG. 7, when a pulse count value is “x” and the total number of collected pulse count values is “n,” the average of deviation is calculated from equation (α) in FIG. 7. The standard deviation is calculated from equation (β) in FIG. 7. In the following specification, the “average of deviation” and the “standard deviation” are referred to as a “deviated value.” In absolute evaluation, the position determination unit 23 determines whether or not the deviated value is smaller than or equal to the threshold value. In relative evaluation, the position determination unit 23 calculates the difference of the deviated values between an evaluated tire and other tires to determine whether or not the difference of the deviated value is greater than or equal to the threshold value, that is, whether or not the deviated value of the evaluated tire of absolute evaluation is sufficiently smaller than the deviated values of other tires. When the deviated value is smaller than or equal to the threshold value in absolute evaluation and the difference of the deviated values is greater than or equal to the threshold value in relative evaluation, the position determination unit 23 recognizes that the axle 18 is rotated in synchronism with the tire 2 and specifies the tire position.

In the example of FIG. 6, with regards to ID1, the pulse count values of the front left axle 18b concentrate around “20.” In such a case, the deviated value of the front left axle 18b is less than or equal to the threshold value, and the front left axle 18b satisfies the absolute evaluation for ID1. However, the pulse count values of the front right axle 18a, the rear right axle 18c, and the rear left axle 18d do not respectively converge at a single value for ID1, and these deviated values are unsatisfactory. Since the difference between the deviated value of the front left axle 18b and the deviated values of the other axles is greater than or equal to the threshold value, the relative evaluation is also satisfied. Thus, the position determination unit 23 determines that the front left axle 18b is rotated in synchronism with the tire 2 of ID1. As a result, the tire 2 of ID1 is determined as being the front left axle 18b. In the same manner, the positions of the tires of ID2 to ID4 are determined.

Operation of Tire Position Display

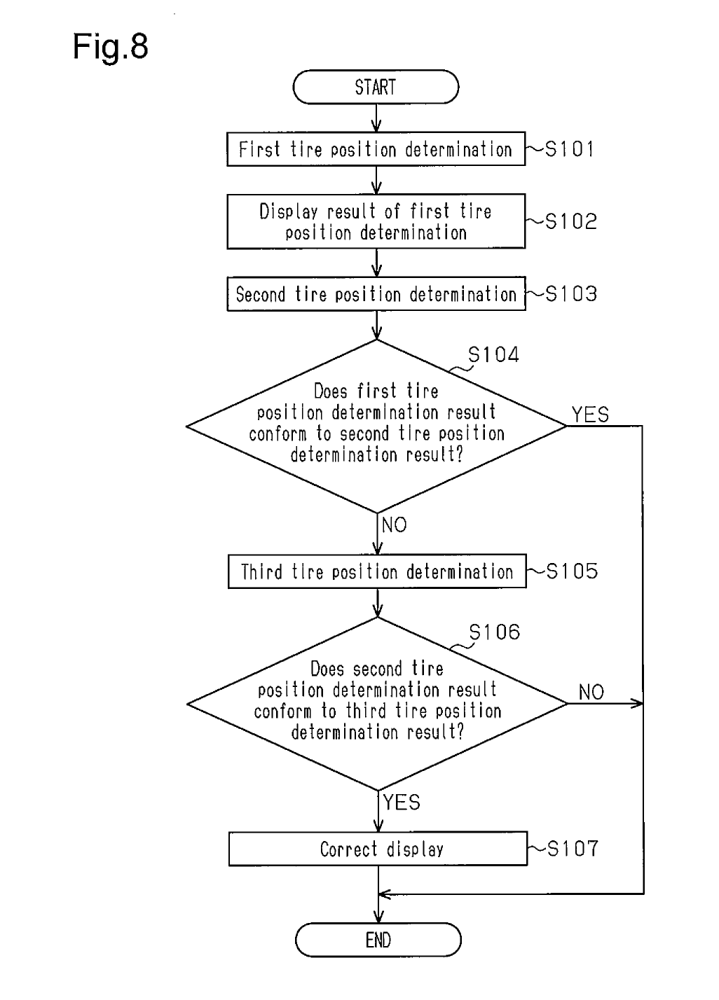

As shown in FIG. 8, in step 101, the position determination unit 23 performs a first tire position determination as a former tire position determination to obtain the determination result of the first tire position determination. It is preferred that the first tire position determination be performed under a moderate determination condition to quickly determine tire positions. In this case, the moderate determination condition may be realized by setting a threshold value of absolute evaluation to a relatively large value and setting a threshold value of relative evaluation to a relatively small value. In such a manner, the position determination unit 23 specifies tire positions in the first tire position determination under the moderate determination condition.

In step 102, the position determination unit 23 shows the tire positions that have been specified in the first tire position determination on the display 16.

In step 103, during the period in which the result of the first tire position determination is shown on the display 16, the re-determination unit 24 has the position determination unit 23 perform a separate second tire position determination as a latter tire position determination and obtains the determination result of the second tire position determination. In this manner, the position determination unit 23 specifies tire positions in the second tire position determination. The position determination unit 23 may perform the second tire position determination under the same determination condition as the first tire position determination or under a different determination condition. The position determination unit 23 may perform the second tire position determination under, for example, a stricter determination condition than the first tire position determination. This determination condition includes, for example, a high-level threshold value that is used to determine the validity of a distribution. Further, this determination condition includes, for example, the employment of at least one of a threshold value set to a relatively small value in absolute evaluation and a threshold value set to a relatively large value in relative evaluation. In such a case, synchronous data is collected under preferred conditions, and a large amount of data is required to determine tire positions. This is advantageous for determining tire positions further correctly. In addition, the second tire position determination may be performed at any time as long as the display 16 shows the first determination result.

In step 104, the validation unit 25 compares the determination result of the first tire position determination with the determination result of the second tire position determination. When the determination result of the first tire position determination conforms to the determination result of the second tire position determination, the validation unit 25 ends the process. When the determination result of the first tire position determination does not conform to the determination result of the second tire position determination, the validation unit 25 proceeds to step 105.

In step 105, during the period in which the display 16 shows the result of the first tire position determination, the re-determination unit 24 has the position determination unit 23 perform a third tire position determination as a latter tire position determination and obtains the determination result in the third tire position determination. In this manner, the position determination unit 23 specifies tire positions in the third tire position determination. The position determination unit 23 may perform the third tire position determination under the same determination condition as the first and second tire position determinations or under a different determination condition. The position determination unit 23 may perform the third tire position determination under, for example, a determination condition that is the same as the second determination condition and stricter than the first tire position determination. In addition, the first to third determination conditions may be set so that the determination condition becomes stricter in steps in the order of the first determination, the second determination, and the third determination.

In step 106, the validation unit 25 compares the determination result of the second tire position determination with the determination result of the third tire position determination. When the determination result of the second tire position determination conforms to the determination result of the third tire position determination, the validation unit 25 ends the process. For example, when the first determination result is the same as the third determination result and the second determination result differs from the first and third determination results, the position determination unit 23 continues to show the first determination result determining that it is correct. When the first to third determination results differ from one another, the position determination unit 23 determines that a correct determination cannot be performed under this condition and continues to show the first determination result. When the determination result of the second tire position determination conforms to the determination result of the third tire position determination, the validation unit 25 proceeds to step 107.

In step 107, since the second determination result is the same as the third determination result, the display controller 26 corrects tire positions shown on the display 16. That is, the display controller 26 determines that the currently shown tire positions are incorrect and corrects the tire positions shown on the display 16 by switching the displayed content to the result of the second (third) tire position determination. This corrects the tire positions shown on the display 16.

The present embodiment has the advantages described below.

(1) First, the former tire position determination (first tire position determination) is performed giving priority to quick determination completion, and the determination result, which is the first determination result, is shown on the display 16. In this manner, the tire position determination result is quickly shown on the display 16. Further, during the period in which the first determination result is shown on the display 16, the latter tire position determinations (second and third tire position determinations) are performed in the same manner as the first tire position determination to compare the determination result of the latter determination, that is, the second determination result, with the first determination result. This determines the validity of the first determination result. When the first determination result is valid, the currently displayed content is continuously shown. When the first determination result is not valid, the displayed content is corrected. This quickly shows the position determination result and ensures the reliability of the displayed content.

(2) The position determination unit 23 performs the former tire position determination under a determination condition that gives priority to time. Thus, the former tire position determination is completed within a short period of time. This is advantageous for quickly showing a tire position determination result on the display 16.

(3) After the first tire position determination is performed, the second and third tire position determinations are performed. Then, a majority vote is taken for the first to third tire position determination results to determine the finally displayed contents. This is further advantageous for reducing an incorrect display of a tire position determination result.

(4) The tire pressure transmitter 4 transmits the ID radio wave signal Spi, which determines that the tire pressure transmitter 4 has reached a peak position on the rotation path of a tire, to the TPMS receiver 12. The TPMS receiver 12 obtains the axle rotation information Dc of each of the axles 18a to 18d when the tire pressure transmitter 4 has reached the peak position. The TPMS receiver 12 performs this operation for each of ID1 to ID4 and for each of the obtained peaks and collects a data group of the axle rotation information Dc that is required for determining tire positions. A distribution of the axle rotation information Dc is obtained for each of ID1 to ID4 by collecting statistics on the axle rotation information Dc of each of the axles 18a to 18d for each of ID1 to ID4. Tire positions are determined from the distribution. In this manner, each axle rotation information Dc is treated as separate data to determine tire positions. Thus, a large amount of data for determining tire positions can be collected within a short period of time. This is advantageous for shortening the time to determine tire positions. Accordingly, tire positions can be determined further correctly within a short period of time.

### Second Embodiment

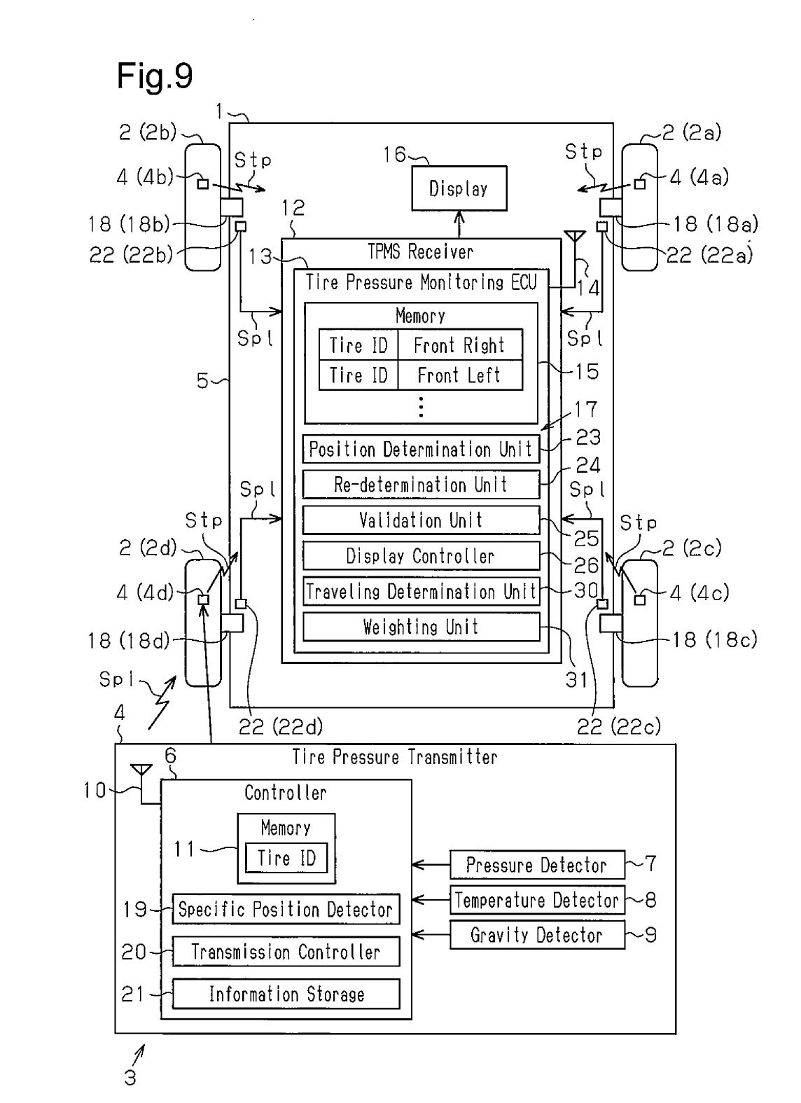

A second embodiment will now be described with reference to FIGS. 9 to 14. In the second embodiment, a correction logic of the tire position display of the first embodiment is modified. Thus, like or same reference numerals are given to those components that are the same as the corresponding components of the first embodiment. The description centers on parts differing from the first embodiment.

It is preferred that the TPMS receiver 12 include, as shown in FIG. 9, a traveling determination unit 30 that determines a traveling state of the vehicle 1 and a weighting unit 31 that weights the second radio wave signal received by the TPMS receiver 12 based on a detection result of the traveling determination unit 30. In one example, the second radio wave signal is an ID radio wave signal Spi. It is preferred that the traveling determination unit 30 and the weighting unit 31 be arranged in, for example, the tire pressure monitoring ECU 13. It is preferred that the traveling determination unit 30 determine a traveling state of the vehicle 1 from changes in the increase and decrease of the axle rotation information Dc. It is preferred that the weighting unit 31 weight (add weighting coefficient K to) the ID radio wave signal Spi in accordance with the traveling state of the vehicle 1. It is preferred that the position determination unit 23 collect statistics using the weighted axle rotation information Dc and determine tire positions based on the distribution that is obtained from the statistics.

Operation when Vehicle is Traveling at Constant Speed

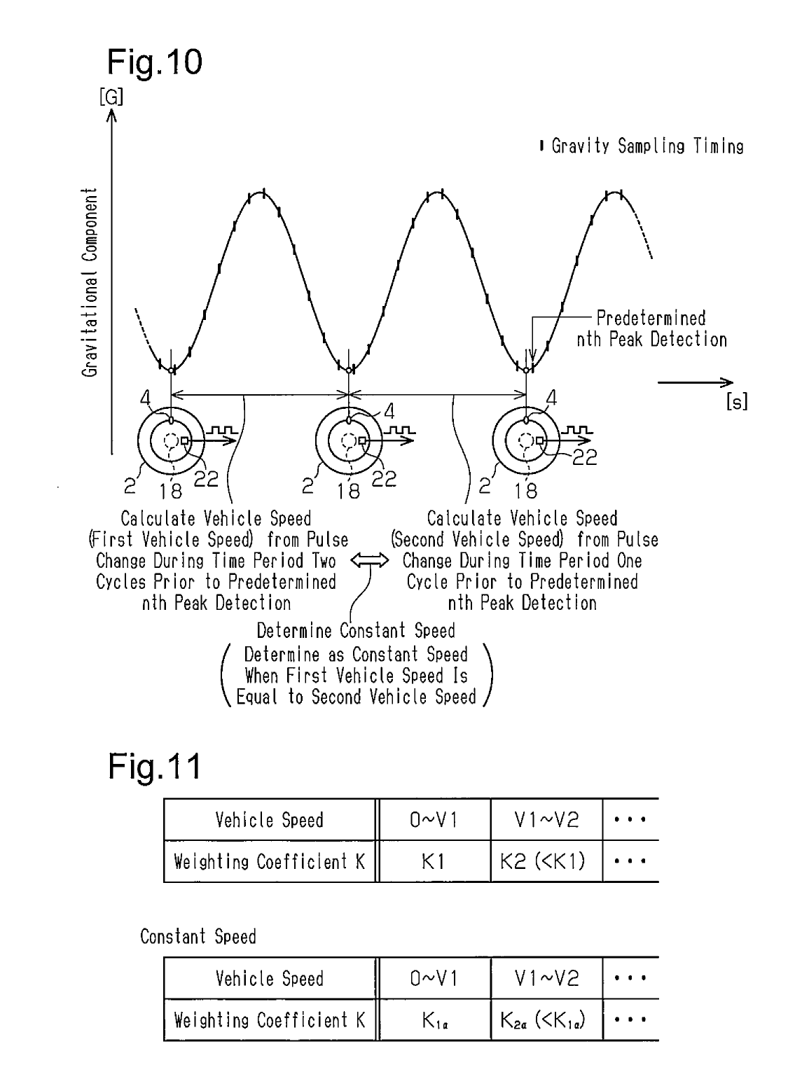

It is preferred that, as shown in FIG. 10, the traveling determination unit 30 perform “determination of vehicle speed” and “determination of constant speed” from the change in the axle rotation information Dc (pulse count value) that is output from the axle rotation detector 22. It is preferred that the determination of a vehicle speed and a constant speed be performed for each of the axles 18a to 18d. For example, the traveling determination unit 30 determines the vehicle speed from the change in the axle rotation information Dc (pulse count value) per tire rotation in a time period that is one cycle prior to when a peak is detected. For example, the vehicle speed when the first peak is detected is calculated based on a pulse change from one cycle prior to the peak detection.

Further, the traveling determination unit 30 determines whether or not the vehicle speed is constant from the difference in vehicle speed between two successive sampling cycles. For example, the traveling determination unit 30 determines whether or not the vehicle speed of a peak detection of a predetermined time is constant by comparing the vehicle speed of a time period two cycles prior to a predetermined nth peak detection (first vehicle speed) and the vehicle speed of a time period one cycle prior to the predetermined nth peak detection (second vehicle speed). More specifically, the traveling determination unit 30 determines whether or not the vehicle speed of the first peak detection is constant by calculating the difference between the vehicle speed two cycles prior to the first peak detection and the vehicle speed one cycle prior to the first peak detection. Further, the traveling determination unit 30 determines whether or not the vehicle speed of the second peak detection is constant by calculating the difference between the vehicle speed two cycles prior to the second peak detection and the vehicle speed one cycle prior to the second peak detection. Such a determination is performed in the same manner for the third and subsequent peaks.

It is preferred that, as shown in FIG. 11, the weighting unit 31 perform weighting taking into account the speed dependency of the axle rotation information Dc for each of the axle rotation detectors 22a to 22d that are obtained when a certain ID is received. For example, when the vehicle speed is “0 to V1,” the weighting unit 31 reflects a weighting coefficient K1 to the read pulse count value. When the vehicle speed is “V1 to V2,” the weighting unit 31 reflects a weighting coefficient K2 (<K1) to the read pulse count value (V1<V2).

Further, the weighting unit 31 may weight a received ID radio wave signal Spi when the vehicle 1 travels at a constant speed. A weighting that is larger than K1 and K2 may be set for weighting coefficients K1a and K2a that are used when the vehicle 1 is traveling at a constant speed. Since the tire pressure transmitter 4 uses the gravity detector 9 to detect gravity, tire positions are accurately detected because the sinusoidal detected waveform of a gravitational centripetal component when the vehicle 1 is traveling at a constant speed allows for easy detection of the peak and the tire 2 undergoes a single rotation in the determined gravity sampling cycle. When the vehicle 1 is traveling at a constant speed that is low, the weighting may be increased. This is because variations in the peak position are small when the vehicle 1 is traveling at the low speed, and tire positions are detected with further accuracy.

Using the axle rotation information Dc weighted in accordance with speed (constant speed traveling) in such a manner, the position determination unit 23 collects statistics for each of ID1 to Id4 and calculates the distribution of the axle rotation information Dc of each of the axles 18a to 18d for ID1 to ID4. The position determination unit 23 adds accuracy data to the axle rotation information Dc to determine tire positions from the distribution that allows for further correct determination. This allows for correct determination of tire positions.

Operation when Vehicle is Accelerating or Decelerating

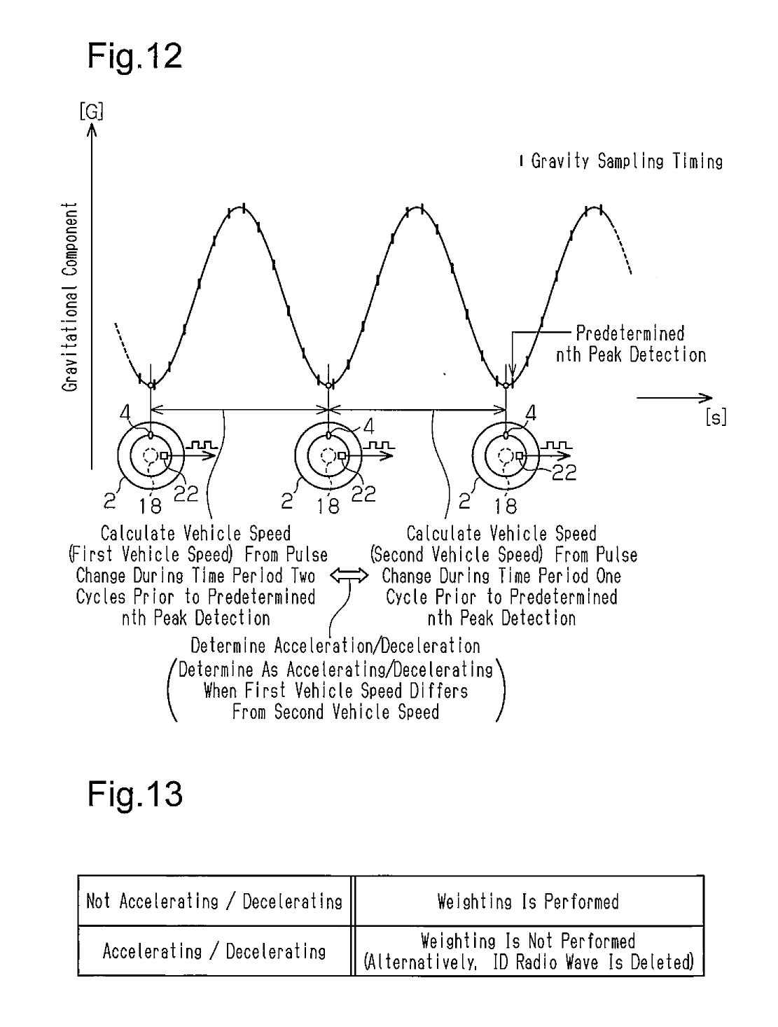

It is preferred that, as shown in FIG. 12, the traveling determination unit 30 determine whether the vehicle 1 is accelerating or decelerating from the change in the axle rotation information Dc (pulse count value) provided by the axle rotation detector 22. It is preferred that the determination of acceleration/deceleration be performed for each of the axles 18a to 18d. The traveling determination unit 30 determines whether the vehicle 1 is accelerating or decelerating from the difference in vehicle speed between two successive sampling periods. For example, the traveling determination unit 30 determines whether or not a vehicle speed of a peak detection of a predetermined time is constant by comparing a vehicle speed of a time period two cycles prior to the predetermined nth peak detection (first vehicle speed) and a vehicle speed of a time period one cycle prior to the predetermined nth peak detection (second vehicle speed). More specifically, the traveling determination unit 30 determines whether the vehicle 1 is accelerating or decelerating during the first peak detection by calculating the difference between the vehicle speed two cycles prior to the first peak detection and the vehicle speed one cycle prior to the first peak detection. Further, the traveling determination unit 30 determines whether the vehicle 1 is accelerating or decelerating during the second peak detection by calculating the difference between the vehicle speed two cycles prior to the second peak detection and the vehicle speed one cycle prior to the second peak detection. Such a determination is performed in the same manner for the third and subsequent peaks to determine whether the vehicle is accelerating or decelerating. The traveling determination unit 30 determines that the vehicle 1 is accelerating when the first vehicle speed is smaller than the second vehicle speed.

It is preferred that, as shown in FIG. 13, the weighting unit 31 perform weighting taking into account the acceleration/deceleration dependency of the axle rotation information Dc for each of the axle rotation detectors 22a to 22d obtained when a certain ID is received. This is because the gravity sampling timing is deviated since the tire 2 rotates once before a single cycle of the gravity sampling is completed when the vehicle 1 accelerates during peak monitoring as a result of the gravity sampling period of the gravitational centripetal component Gr set in advance of the peak detection, that is, the gravity sampling interval time, which is the interval at which gravity sampling is performed, being constant during sampling. The same applies to when the vehicle 1 is decelerating. Thus, the axle rotation information Dc obtained when the vehicle 1 is accelerating or decelerating is determined as unsatisfactory data and then processed. It is preferred that the weighting unit 31 do not weight the received ID radio wave signal Spi when the vehicle 1 is accelerating or decelerating. Further, the received ID radio wave signal Spi may be deleted when the vehicle 1 is accelerating or decelerating or when the acceleration or deceleration is a specified value or greater.

The position determination unit 23 collects statistics for each of ID1 to ID4 using the axle rotation information Dc that is weighted in accordance with the acceleration/deceleration of the vehicle 1 and calculates the distribution of the axle rotation information Dc of each of the axles 18a to 18d for ID1 to ID4. The position determination unit 23 adds accuracy information to the data of the axle rotation information Dc and determines tire positions from the distribution that allows for further correct determination. This allows for correct determination of tire positions.

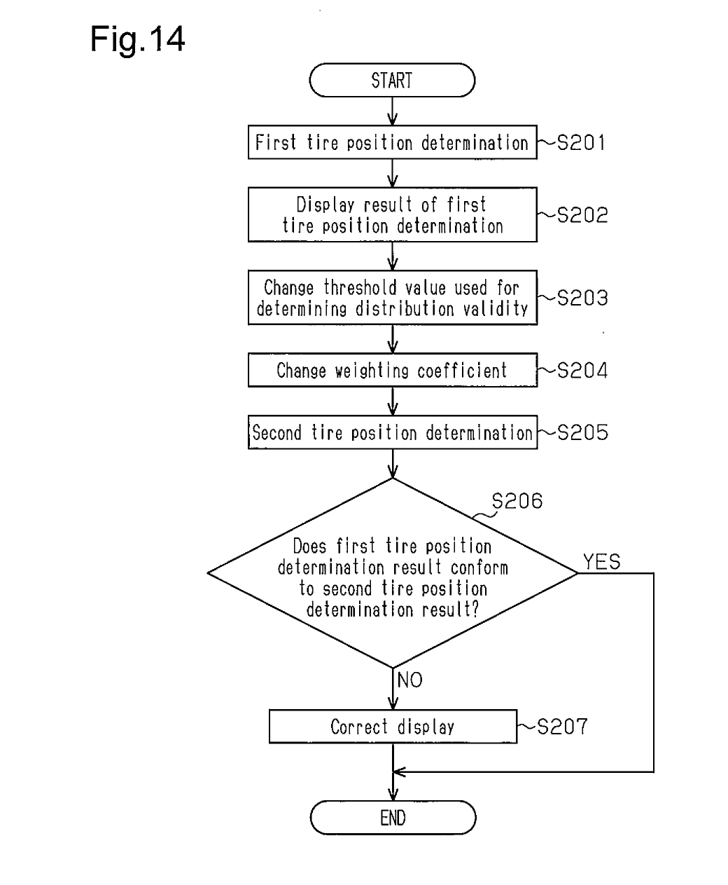

It is preferred that, as shown in FIG. 14, the re-determination unit 24 perform the latter tire position determination under a stricter determination condition than the former tire position determination. A strict determination condition may be realized by setting the “threshold value” of the determination process to, for example, a high-level value (strict value) in the process of “variation,” “average of deviation,” and “standard deviation.” In this case, the strict determination condition may be realized by using at least one of a threshold value set to a relatively small value in absolute evaluation and a threshold value set to a relatively large value in relative evaluation.

The operation of the tire position determination system 17 will now be described with reference to FIG. 14.

In step 201, the position determination unit 23 performs a first tire position determination as a former tire position determination and obtains the determination result of the first tire position determination. It is preferred that the position determination unit 23 perform the first tire position determination under a moderate condition to quickly determine tire positions. The moderate determination condition is not limited to a “threshold value” set to a low level. The moderate determination condition may include, for example, a “threshold value” set to a normal value.

In step 202, the position determination unit 23 shows the tire position specified in the first tire position determination on the display 16.

In step 203, when the re-determination unit 24 has the position determination unit 23 perform a latter tire position determination, the re-determination unit 24 switches the threshold value for determining the validity of a distribution to a high-level value. In this case, as described above, the strict determination condition has at least one of a threshold value set to a relatively small value in absolute evaluation and a threshold value set to a relatively large value in relative evaluation. In this manner, synchronous data is collected in a preferred manner, and a large amount of data is required to determine tire positions. This is advantageous for determining tire positions further correctly.

In step 204, when the re-determination unit 24 has the position determination unit 23 perform the latter tire position determination, the re-determination unit 24 switches the weighting coefficient K to a high-level value. The degree of weighting is changed by determining a state of the vehicle 1 from the axle rotation information Dc and checking the accuracy of the ID radio wave signal Spi from the determination result to, for example, assign a large weighting to an ID radio wave signal Spi having high accuracy and assign a small weighting to the ID radio wave signal Spi having low accuracy. This is also advantageous for determining tire positions further correctly although it takes time to specify tire positions.

In step 205, during the period in which the result of the first tire position determination is shown on the display 16, the re-determination unit 24 has the position determination unit 23 perform a latter tire position determination in accordance with the determination conditions set in steps 203 and 204 and obtains the determination result of a second tire position determination. That is, the position determination unit 23 specifies tire positions in the second tire position determination.

In step 206, the validation unit 25 compares the determination result of the first tire position determination with the determination result of the second tire position determination. When the determination result of the first tire position determination conforms to the determination result of the second tire position determination, the validation unit 25 ends the process. When the determination result of the first tire position determination does not conform to the determination result of the second tire position determination, the validation unit 25 proceeds to step 207.

In step 207, since the first determination result differs from the second determination result, the display controller 26 corrects tire positions shown on the display 16. The display controller 26 determines that the currently shown tire positions are incorrect and corrects the displayed content of the tire positions shown on the display 16 by switching the display to the result of the second tire position determination. In this manner, the tire position display of the display 16 is corrected.

In addition to advantages (1), (2), and (4) of the first embodiment, the structure of the second embodiment has the advantage described below.

(5) Priority is given to a quick determination in the first tire position determination performed under a moderate determination condition, and priority is given to an accurate determination in the second tire position determination performed under a strict determination condition. In this manner, when the second tire position determination is performed under a strict determination condition, the validity of the result of the first tire position determination is determined accurately. This is further advantageous for reducing an incorrect display of a tire position determination result.

The first and second embodiments are not limited to the foregoing structure. It should be understood that the embodiment may be implemented in the following forms.

In the first embodiment, the number of times the second and subsequent tire position determinations are performed is not limited to two and may be three or more.

In the second embodiment, a method for performing tire position determination under a strict condition may be changed to various types of determination methods as long as the method gives priority to accuracy.

In each of the embodiments, in the first time period T1, the specific position information Dtm collected in the second time period T2 may all be transmitted during the first radio wave transmission.

In the first and second embodiments, the specific position information Dtm may include various types of information, for example, the time at which a peak position is detected or a time going back from the starting point T1a of a first time period T1.

In the first and second embodiments, a specific position does not have to be a peak position. Instead, a specific position may be a predetermined certain position at which the tire pressure transmitter 4 is located in the direction of tire rotation.

In the first and second embodiments, the axle rotation detector 22 may output a pulse count value detected during each of certain time intervals to the TPMS receiver 12 as count data.

In the first and second embodiments, the axle rotation detector 22 is not limited to the ABS sensor. Instead, the axle rotation detector 22 may be a member that detects a rotation position of the axle 18.

In the first and second embodiments, the axle rotation detector 22 may transmit a detection signal to the TPMS receiver 12 through wireless communication.

In the first and second embodiments, the axle rotation information Dc is not limited to a pulse count value. Instead, the axle rotation information Dc may be changed to other parameters as long as the axle rotation information Dc is similar to a rotation position of the axle 18.

In the first and second embodiments, the method for weighting may be changed in accordance with various aspects.

In the first and second embodiments, the tire pressure transmitter 4 does not have to detect a peak in advance in the second time period T2, during which radio waves are not transmitted. Instead, the tire pressure transmitter 4 may transmit the ID radio wave signal Spi when detecting a peak in the first time period T1 that allows transmission of radio waves.

In the first and second embodiments, the tire pressure transmitter 4 may periodically transmit the ID radio wave signal Spi.

In the first and second embodiments, the method for determining tire positions is not limited to a method for determining positions by obtaining a distribution of the axle rotation information Dc of each of the axles 18a to 18d for each of the IDs as described in the embodiments. For example, tire positions may be determined by calculating the average of the axle rotation information Dc of each of the axles 18a to 18d for each ID and determining the one of the average values with which the ID synchronizes. In such a manner, the tire position determination method may be changed in various manners.

In the first and second embodiments, the first radio wave signal and the second radio wave signal may be the same radio wave signal.

In the first and second embodiments, the determination method may completely differ between the first tire position determination and the second tire position determination.

In the first and second embodiments, distribution is not limited to variation, average of deviation, and standard deviation. Instead, distribution may be changed to other parameters as long as synchronization of a tire ID and an axle 18 is recognizable.

1. A tire position determination system comprising:
tire pressure transmitters respectively coupled to tires, wherein each of the tire pressure transmitters is capable of transmitting a first radio wave signal that includes pressure data and a tire ID;
axle rotation detectors respectively arranged on axles, wherein each of the axle rotation detectors detects rotation of a corresponding one of the axles and generates axle rotation information; and
a receiver arranged on a vehicle body, wherein the receiver is capable of receiving the first radio wave signal from each of the tire pressure transmitters, wherein
each of the tire pressure transmitters transmits a second radio wave signal, which includes an ID of the tire and data indicating that the tire pressure transmitter has reached a specific position on the rotation path of the tire, and
the receiver includes:
a position determination unit that obtains the axle rotation information from each of the axle rotation detectors whenever receiving the second radio wave signal from each of the tire pressure transmitters and specifies an ID of a tire that rotates in synchronism with each of the axles based on the obtained axle rotation information to determine tire positions of the tires and generate a first determination result;
a display that shows the first determination result of the position determination unit;
a re-determination unit that obtains, during a period in which the display shows the first determination result, the axle rotation information from each of the axle rotation detectors whenever receiving the second radio wave signal from the tire pressure transmitter and specifies an ID of a tire that rotates in synchronism with each of the axles based on the obtained axle rotation information to determine tire positions of the tires and generate a second determination result;
a validation unit that checks validity of the first determination result based on the first determination result and the second determination result; and
a display controller that shows one of the first determination result and the second determination result on the display based on a check result of the validation unit.

2. The tire position determination system according to claim 1, wherein the position determination unit determines a tire position under a determination condition set in accordance with a determination order.

3. The tire position determination system according to claim 1, wherein
during a period in which the display shows the first determination result, the re-determination unit performs determination of the tire positions a number of times to generate a plurality of determination results including a second determination result and a third determination result, and
the validation unit takes a majority vote with the first determination result and the plurality of determination results to determine the validity of the first determination result.

4. The tire position determination system according to claim 1, wherein
the re-determination unit determines tire positions of the tires to generate a third determination result by, whenever the second radio wave signal is received from the tire pressure transmitter, after the second determination result is generated while the display shows the first determination result, obtaining the axle rotation information from each of the axle rotation detectors and specifying an ID of a tire that rotates in synchronism with each of the axles based on the obtained axle rotation information, and
the validation unit checks validity of the first determination result by taking a majority vote with the first determination result, the second determination result, and the third determination result.

5. The tire position determination system according to claim 1, wherein the re-determination unit determines a tire position under a stricter determination condition than the determination condition of a tire position for the position determination unit.

6. The tire position determination system according to claim 1, wherein the position determination unit collects statistics on the axle rotation information for each of the IDs and calculates a distribution of the axle rotation information of each of the axles for each of the IDs to specify an ID of a tire that rotates in synchronism with each of the axles based on the calculated distribution and determine tire positions of the tires.

7. The tire position determination system according to claim 1, wherein
a first time period, during which transmission of a radio wave signal is enabled, and a second time period, during which transmission of a radio wave signal is temporarily stopped, are alternately repeated in an operation of the tire pressure transmitter, and
each of the tire pressure transmitters obtains multiple pieces of timing information indicating a time at which each of the tire pressure transmitters reached a specific position on a rotation path of the tire during the first time period and transmits the second radio wave signal including an ID of the tire and the multiple pieces of timing information during the second time period.
